(19) United States
(12) Patent Application Publication
(10) Pub. No.: US 2002/0010932 A1
(43) Pub. Date: Jan. 24, 2002

(54) Integration of web-based EPG with TV functions

(76) Inventors: Nga Marie Nguyen, Carlsbad, CA (US); Toshiro Ozawa, San Diego, CA (US)

Correspondence Address: Miller Patent Services, 29 Seminole Dr., Ringwood, NJ, 07456, US

(21) Appl. No.: 09/815,852

(22) Filed: Mar. 23, 2001

Related U.S. Application Data
(60) Provisional application No. 60/197,310, filed on Apr. 14, 2000.
(60) Provisional application No. 60/197,848, filed on Apr. 14, 2000.
(60) Provisional application No. 60/197,308, filed on Apr. 14, 2000.
(60) Provisional application No. 60/197,233, filed on Apr. 14, 2000.
(60) Provisional application No. 60/197,234, filed on Apr. 14, 2000.
(60) Provisional application No. 60/197,320, filed on Apr. 14, 2000.

(51) Int. Cl. G06F 3/00

(52) U.S. Cl. 725/51

(57) ABSTRACT

A web based electronic program guide (EPG) is integrated with other television functions. Upon execution of a hot key (704) during normal television mode operation (408), a browser (182) is invoked and directed to the URL of a preferred program guide using the cable or satellite system's high speed data capabilities. While the browser (182) is invoked, receipt of a TV command is detected by rejection of such a command (610) by the browser (182) and redirection of the command by an event manager (510) to a TV manager module (520) that controls the hardware of the television or set-top box function.

### CROSS REFERENCE TO RELATED DOCUMENTS

This application is related to and claims priority benefit under 35 U.S.C. § 119(e) or 35 U.S.C. § 120 of Provisional Patent Application No. 60/197,848, filed Apr. 14, 2000, Attorney Docket Number 50P3988, and entitled “User Interface for a Set-Top Box”, Provisional Patent Application 60/197,308, filed Apr. 14, 2000, Attorney Docket Number 50P3984, and entitled “Method for VOD”, Provisional Patent Application No. 60/197,233, filed Apr. 14, 2000, Attorney Docket Number 50P3877, and entitled “Cable Modem Set Top Box”, Provisional Patent Application No. 60/197,234, filed Apr. 14, 2000, Attorney Docket Number 50P3985, and entitled “Web Based EPG Support”, and Provisional Patent Application No. 60/197,320, filed Apr. 14, 2000, Attorney Docket Number 50P3983, and entitled “Support for tuning while viewing a Web Based EPG”, and U.S. patent application Ser. No. ______ filed Feb. 3, 2001 entitled “Web Browser Plug in for TV” to Kimble et al. Docket No. 50N3463 which are each hereby incorporated by reference. U.S. patent application Ser. No. 09/473,625, filed Dec. 29, 1999, Docket No. SONY-50N3508 entitled “Improved Internet Set-Top Box Having and In-Band Tuner and Cable Modem” is also hereby incorporated herein by reference.

### COPYRIGHT NOTICE

A portion of the disclosure of this patent document contains material which is subject to copyright protection. The copyright owner has no objection to the facsimile reproduction of the patent document or the patent disclosure, as it appears in the Patent and Trademark Office patent file or records, but otherwise reserves all copyright rights whatsoever.

### FIELD OF THE INVENTION

This invention relates generally to the field of integration of a web based electronic program guide (EPG) or other web-based services with normal television functions.

### BACKGROUND OF THE INVENTION

Table and satellite television systems often utilize an electronic program guide (EPG) that assists the user in selecting television programming to watch. Conventionally, such a program guide is provided by the cable or satellite service operator. However, increasingly such guides are available for multiple sources including various Internet services. Unfortunately, utilizing such a web based EPG is cumbersome since a user generally requires a computer connection to the Internet followed by actions to address a particular web site in order to access a particular web based EPG. Thus, a user's options on which electronic programming guide to utilize are, for all practical purposes, limited to that supplied by the cable or satellite service provider.

### SUMMARY OF THE INVENTION

The present invention relates generally to integration of web based EPG with television functions. Objects, advantages and features of the invention will become apparent to those skilled in the art upon consideration of the following detailed description of the invention.

In one embodiment consistent with the present invention a A web based electronic program guide (EPG) is integrated with other television functions. Upon execution of a hot key during normal television mode operation, a browser is invoked and directed to the URL of a preferred program guide using the cable or satellite system's high speed data capabilities. While the browser is invoked, receipt of a TV command is detected by rejection of such a command by the browser and redirection of the command by an event manager to a TV manager module that controls the hardware of the television or set-top box function.

A method, consistent with an embodiment of the invention, of tuning a television channel while displaying a web-based program guide includes generating a video signal to display the web-based program guide using a web browser application, the display indicating a cursor location; receiving an input signal; determining that the input signal is unmatched to the current cursor location; and redirecting the input signal to a television manager.

A television set-top box, consistent with an embodiment of the invention includes a programmed processor. A web browser runs on the programmed processor, the web browser accessing a web page as a current web page. An input receives a user input signal, wherein the user input signal may be directed either to a television control action or to the current web page. A television manager receives user input signals and implements television control actions in response thereto. An event manager directs the input signal to the television manager in the event the input signal is not directed to the current web page.

In another embodiment consistent with the present invention, an electronic storage medium storing instructions which, when executed on a programmed processor, carry out a process of tuning a television channel, includes generating a video signal to display a web-based program guide using a web browser application, the display indicating a cursor location; receiving an input signal; determining that the input signal is unmatched to the current cursor location; and redirecting the input signal to a television manager.

A method of invoking an electronic program guide consistent with an embodiment of the invention includes producing a video signal corresponding to a television program; receiving an input command to display a program guide; invoking a web browser application directed to a Universal Resource Locator (URL) calling a web-based program guide; and producing a video signal to display the web-based program guide.

A method of changing from a television mode to a browser mode consistent with another embodiment of the invention includes producing a video signal corresponding to a television program; receiving an input command; invoking a web browser application directed to a default Universal Resource Locator (URL) in response to the input command; and producing a video signal to display a web page corresponding to the URL.

Another television set-top box or television receiver device consistent with embodiments of the present invention includes a programmed processor. A web browser application runs on the programmed processor. An input receives a user input signal, wherein the user input signal includes a command to display a program guide, the command being passed from the input to the programmed processor. Wherein, the programmed processor invokes the web browser application directed to a Universal Resource Locator (URL) calling a web-based program guide page as a result of the input receiving the command to display a program guide.

The above summaries are intended to illustrate exemplary embodiments of the invention, which will be best understood in conjunction with the detailed description to follow, and are not intended to limit the scope of the appended claims.

### BRIEF DESCRIPTION OF THE DRAWINGS

The features of the invention believed to be novel are set forth with particularity in the appended claims. The invention itself however, both as to organization and method of operation, together with objects and advantages thereof, may be best understood by reference to the following detailed description of the invention, which describes certain exemplary embodiments of the invention, taken in conjunction with the accompanying drawings in which:

FIG. 1 is a system block diagram of a system using a set-top box.

FIG. 2 is a functional block diagram of a digital set-top box suitable for use with the present invention.

FIG. 3 is an exemplary web-based EPG similar to that provided by Yahoo!.

FIG. 4 is a high level flow chart depicting the operation of an embodiment consistent with the present invention.

FIG. 5 illustrates the interaction of a browser, event manager and TV manager in accordance with an embodiment consistent with the present invention.

FIG. 6 is a flow chart depicting the operation of the system of FIG. 5 in making a transition from the idle browser state to normal television mode operation in accordance with an embodiment of the invention.

FIG. 7 is a flow chart depicting the transition between normal television mode and browser idle mode showing greater detail in implementing television commands in accord with an embodiment consistent with the present invention.

FIG. 8 illustrates an exemplary menu system for setting a default EPG consistent with an embodiment of the invention.

### DETAILED DESCRIPTION OF THE INVENTION

While this invention is susceptible of embodiment in many different forms, there is shown in the drawings and will herein be described in detail specific embodiments, with the understanding that the present disclosure is to be considered as an example of the principles of the invention and not intended to limit the invention to the specific embodiments shown and described. In the description below, like reference numerals are used to describe the same, similar or corresponding parts in the several views of the drawings.

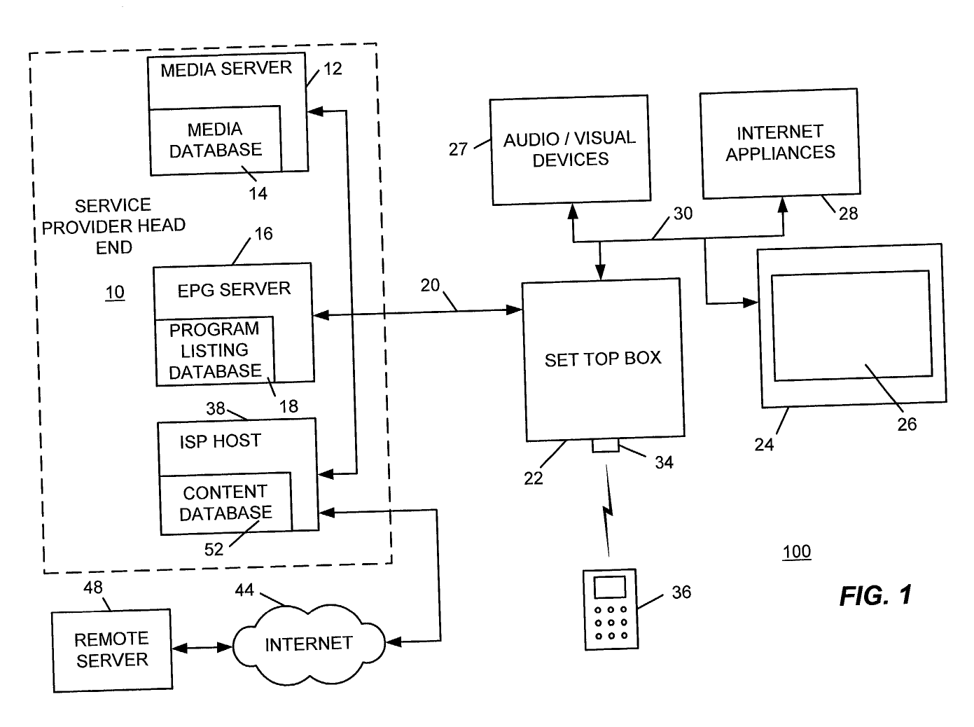

Referring to FIG. 1, a block diagram for an exemplary interactive cable or satellite television (TV) system 100 is shown. The system 100 includes, at a head end of the service provider 10, a media server 12 for providing on demand, movies and other programming obtained from a media database 14. The media server 12 might also provide additional content such as interviews with the actors, games, advertisements, available merchandise, associated Web pages, interactive games and other related content. The system 100 also conventionally includes an electronic programming guide (EPG) server 16 and a program listing database 18 for generating an EPG that is accessed by the user by simply tuning to a specified channel. In the present invention, a web-based electronic program guide can be used instead. Set-top box 22 can generally provide for bidirectional communication over a transmission medium 20 in the case of a cable STB 22. In other embodiments, bidirectional communication can be effected using asymmetrical communication techniques possibly using dual communication media—one for the uplink and one for the downlink. In any event, the STB 22 can have its own Universal Resource Locator (URL) or IP address or other unique identifier assigned thereto to provide for addressability by the head end and users of the Internet.

The media server 12 and EPG server 16 are operatively coupled by transmission medium 20 to a set-top box (STB) 22. The transmission medium 20 may include, for example, a conventional coaxial cable network, a fiber optic cable network, telephone system, twisted pair, a satellite communication system, a radio frequency (RF) system, a microwave system, other wireless systems, a combination of wired and wireless systems or any of a variety of known electronic transmission mediums. In the case of a cable television network, transmission medium 20 is commonly realized at the subscriber's premises as a coaxial cable that is connected to a suitable cable connector at the rear panel of the STB 22. In the case of a Direct Satellite System (DSS), the STB 22 is often referred to as an Integrated Receiver Decoder (IRD). In the case of a DSS system, the transmission medium is a satellite transmission at an appropriate microwave band. Such transmissions are typically received by a satellite dish antenna with an integral Low Noise Block (LNB) that serves as a down-converter to convert the signal to a lower frequency for processing by the STB 22.

The exemplary system 100 further includes a TV 24, such as a digital television, having a display 26 for displaying programming, an EPG, etc. The STB 22 may be coupled to the TV 24 and various other audio/visual devices 26 (such as audio systems, Personal Video Recorders (PVRs), Video Tape Recorders (VTRs), Video Cassette Recorders (VCRs) and the like), storage devices (e.g., hard disc drives) and Internet Appliances 28 (such as email devices, home appliances, storage devices, network devices, and other Internet Enabled Appliances) by an appropriate interface 30, which can be any suitable analog or digital interface. In one embodiment, interface 30 conforms to an interface standard such as the Institute of Electrical and Electronics Engineers (IEEE) 1394 standard, but could also be wholly or partially supported by a DVI interface (Digital Visual Interface—Digital Display Working Group, www.ddwg.org) or other suitable interface.

The STB 22 may include a central processing unit (CPU) such as a microprocessor and memory such as Random Access Memory (RAM), Read Only Memory (ROM), flash memory, mass storage such as a hard disc drive, floppy disc drive, optical disc drive or may accommodate other electronic storage media, etc. Such memory and storage media is suitable for storing data as well as instructions for programmed processes for execution on the CPU, as will be discussed later. Information and programs stored on the electronic storage media or memory may also be transported over any suitable transmission medium such as that illustrated as 20. STB 22 may include circuitry suitable for audio decoding and processing, the decoding of video data compressed in accordance with a compression standard such as the Motion Pictures Experts Group (MPEG) standard and other processing to form a controller or central hub. Alternatively, components of the STB 22 may be incorporated into the TV 24 itself, thus eliminating the STB 22. Further, a computer having a tuner device and modem may be equivalently substituted for the TV 24 and STB 22.

By way of example, the STB 22 may be coupled to devices such as a personal computer, video cassette recorder, camcorder, digital camera, personal digital assistant and other audio/visual or Internet related devices. In addition, a data transport architecture, such as that set forth by an industry group which includes Sony Corporation and known as the Home Audio-Video Interoperability (HAVi) architecture may be utilized to enable interoperability among devices on a network regardless of the manufacturer of the device. This forms a home network system wherein electronic devices and Internet appliances are compatible with each other. The STB 22 runs an operating system suitable for a home network system such as Sony Corporation's Aperios™ real time operating system. Other operating systems could also be used.

The STB 22 includes an infrared (IR) receiver 34 for receiving IR signals from an input device such as remote control 36. Alternatively, it is noted that many other control communication methods may be utilized besides IR, such as wired or wireless radio frequency, etc. In addition, it can be readily appreciated that the input device 36 may be any device suitable for controlling the STB 22 such as a remote control, personal digital assistant, laptop computer, keyboard or computer mouse. In addition, an input device in the form of a control panel located on the TV 24 or the STB 22 can be provided.

The STB 22 may also be coupled to an independent service provider (ISP) host 38 by a suitable connection including dial-up connections, DSL (Digital Subscriber Line) or the same transmission medium 20 described above (e.g., using a cable modem and/or an out-of-band modem) to, thus, provide access to services and content from the ISP and the Internet. The ISP host 38 provides various content to the user that is obtained from a content database 42. STB 22 may also be used as an Internet access device to obtain information and content from remote servers such as remote server 48 via the Internet 44 using host 38 operating as an Internet portal, for example. In certain satellite STB environments, the data can be downloaded at very high speed from a satellite link, with asymmetrical upload speed from the set-top box provided via a dial-up or DSL connection.

While the arrangement illustrated in FIG. 1 shows a plurality of servers and databases depicted as independent devices, any one or more of the servers can operate as server software residing on a single computer. Moreover, although not explicitly illustrated, the servers may operate in a coordinated manner under centralized or distributed control to provide multiple services as a Multiple Service Operator (MSO) in a known manner. Additionally, the services provided by the servers shown in FIG. 1 may actually reside in other locations, but from the perspective of the user of STB 22, the service provider 10 serves as a portal to the services shown. Those skilled in the art will appreciate that the illustration of FIG. 1 represents a simplified depiction of a cable system configuration shown simply as service provider 10. The actual configuration of the service provider's equipment is more likely to follow a configuration defined by the CableLabs OpenCable™ specification. The simplified illustration shown is intended to simplify the discussion of the service provider 10's operation without unnecessarily burdening the discussion with architectural details that will be evident to those skilled in the art. Those details can be found in the publicly available CableLabs OpenCable™ specification or in the text “OpenCable Architecture (Fundamentals)” by Michael Adams, Cisco Press, November 1999.

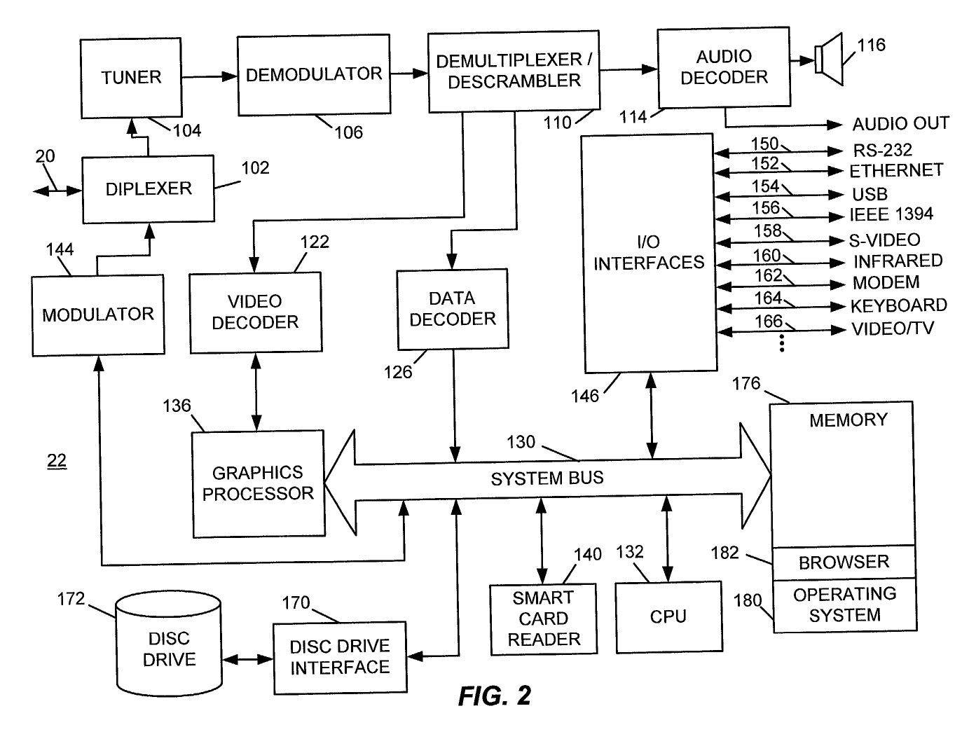

Referring now to FIG. 2, a typical system configuration for a digital set-top box 22 is illustrated. In this exemplary set-top box, the transmission medium 20, such as a coaxial cable, is coupled by a suitable interface through a diplexer 102 to a tuner 104. Tuner 104 may, for example, include a broadcast in-band tuner for receiving content, an out-of-band (OOB) tuner for receiving data transmissions. A return path through diplexer 102 provides an OOB return path for outbound data (destined for example for the head end). A separate tuner (not shown) may be provided to receive conventional RF broadcast television channels. Modulated information formatted, for example, as MPEG-2 information is then demodulated at a demodulator 106. The demodulated information at the output of demodulator 106 is provided to a demultiplexer and descrambler circuit 110 where the information is separated into discrete channels of programming. The programming is divided into packets, each packet bearing an identifier called a Packet ID (PID) that identifies the packet as containing a particular type of data (e.g., audio, video, data). The demodulator and descrambler circuit 110 also decrypts encrypted information in accordance with a decryption algorithm to prevent unauthorized access to programming content, for example.

Audio packets from the demultiplexer 110 (those identified with an audio PID) are decrypted and forwarded to an audio decoder 114 where they may be converted to analog audio to drive a speaker system (e.g., stereo or home theater multiple channel audio systems) or other audio system 116 (e.g., stereo or home theater multiple channel amplifier and speaker systems) or may simply provide decoded audio out at 118. Video packets from the demultiplexer 110 (those identified with a video PID) are decrypted and forwarded to a video decoder 122. In a similar manner, data packets from the demultiplexer 110 (those identified with a data PID) are decrypted and forwarded to a data decoder 126.

Decoded data packets from data decoder 126 are sent to the set-top box's computer system via the system bus 130. A central processing unit (CPU) 132 can thus access the decoded data from data decoder 126 via the system bus 130. Video data decoded by video decoder 122 is passed to a graphics processor 136, which is a computer optimized to processes graphics information rapidly. Graphics processor 136 is particularly useful in processing graphics intensive data associated with Internet browsing, gaming and multimedia applications such as those associated with MHEG (Multimedia and Hypermedia information coding Experts Group) set-top box applications. It should be noted, however, that the function of graphics processor 136 may be unnecessary in some set-top box designs having lower capabilities, and the function of the graphics processor 136 may be handled by the CPU 132 in some applications where the decoded video is passed directly from the demultiplexer 110 to a video encoder. Graphics processor 136 is also coupled to the system bus 130 and operates under the control of CPU 132.

Many set-top boxes such as STB 22 may incorporate a smart card reader 140 for communicating with a so called “smart card,” often serving as a Conditional Access Module (CAM). The CAM typically includes a central processor unit (CPU) of its own along with associated RAM and ROM memory. Smart card reader 140 is used to couple the system bus of STB 22 to the smart card serving as a CAM (not shown). Such smart card based CAMs are conventionally utilized for authentication of the user and authentication of transactions carried out by the user as well as authorization of services and storage of authorized cryptography keys. For example, the CAM can be used to provide the key for decoding incoming cryptographic data for content that the CAM determines the user is authorized to receive.

STB 22 can operate in a bidirectional communication mode so that data and other information can be transmitted not only from the system's head end to the end user, or from a service provider to the end user of the STB 22, but also, from the end user upstream using an out-of-band channel. In one embodiment, such data passes through the system bus 130 to a modulator 144 through the diplexer 102 and out through the transmission medium 20. This capability is used to provide a mechanism for the STB 22 and/or its user to send information to the head end (e.g., service requests or changes, registration information, etc.) as well as to provide fast outbound communication with the Internet or other services provided at the head end to the end user.

Set-top box 22 may include any of a plurality of I/O (Input/Output) interfaces represented by I/O interfaces 146 that permit interconnection of I/O devices to the set-top box 22. By way of example, and not limitation, a serial RS-232 port 150 can be provided to enable interconnection to any suitable serial device supported by the STB 22's internal software. Similarly, communication with appropriately compatible devices can be provided via an Ethernet port 152, a USB (Universal Serial Bus) port 154, an IEEE 1394 (so-called firewire™ or i-link™) or IEEE 1394 wide port 156, S-video port 158 or infrared port 160. Such interfaces can be utilized to interconnect the STB 22 with any of a variety of accessory devices such as storage devices, audio/visual devices 26, gaming devices (not shown), Internet Appliances 28, etc.

I/O interfaces 146 can include a modem (be it dial-up, cable, DSL or other technology modem) having a modem port 162 to facilitate high speed or alternative access to the Internet or other data communication functions. In one preferred embodiment, modem port 162 is that of a DOCSIS (Data Over Cable System Interface Specification) cable modem to facilitate high speed network access over a cable system, and port 162 is appropriately coupled to the transmission medium 20 embodied as a coaxial cable. Thus, the STB 22 can carry out bidirectional communication via the DOCSIS cable modem with the STB 22 being identified by a unique IP address. The DOCSIS specification is publically available.

A PS/2 or other keyboard/mouse/joystick interface such as 164 can be provided to permit ease of data entry to the STB 22. Such inputs provide the user with the ability to easily enter data and/or navigate using pointing devices. Pointing devices such as a mouse or joystick may be used in gaming applications.

Of course, STB 22 also may incorporate basic video outputs 166 that can be used for direct connection to a television set such as 24 instead of (or in addition to) an IEEE 1394 connection such as that illustrated as 30. In one embodiment, Video output 166 can provide composite video formatted as NTSC (National Television System Committee) video. In some embodiments, the video output 166 can be provided by a direct connection to the graphics processor 136 or the demultiplexer/descrambler 110 rather than passing through the system bus 130 as illustrated in the exemplary block diagram. S-Video signals from output 158 can be similarly provided without passing through the system bus 130 if desired in other embodiments.

The infrared port 160 can be embodied as an infrared receiver 34 as illustrated in FIG. 1, to receive commands from an infrared remote control 36, infrared keyboard or other infrared control device. Although not explicitly shown, front panel controls may be used in some embodiments to directly control the operation of the STB 22 through a front panel control interface as one of interfaces 146. Selected interfaces such as those described above and others can be provided in STB 22 in various combinations as required or desired.

STB 22 will more commonly, as time goes on, include a disc drive interface 170 and disc drive mass storage 172 for user storage of content and data as well as providing storage of programs operating on CPU 132. STB 22 may also include floppy disc drives, CD ROM drives, CD R/W drives, DVD drives, etc. CPU 132, in order to operate as a computer, is coupled through the system bus 130 (or through a multiple bus architecture) to memory 176. Memory 178 may include a combination any suitable memory technology including Random Access Memory (RAM), Read Only Memory (ROM), Flash memory, Electrically Erasable Programmable Read Only Memory (EEPROM), etc.

While the above exemplary system including STB 22 is illustrative of the basic components of a digital set-top box suitable for use with the present invention, the architecture shown should not be considered limiting since many variations of the hardware configuration are possible without departing from the present invention. The present invention could, for example, also be implemented in more advanced architectures such as that disclosed in U.S. patent application Ser. No. 09/473,625, filed Dec. 29, 1999, Docket No. SONY-50N3508 entitled “Improved Internet Set-Top Box Having and In-Band Tuner and Cable Modem” to Jun Maruo and Atsushi Kagami. This application describes a set-top box using a multiple bus architecture with a high level of encryption between components for added security. This application is hereby incorporated by reference as though disclosed fully herein.

In general, during operation of the STB 22, an appropriate operating system 180 such as, for example, Sony Corporation's Aperios™ real time operating system is loaded into, or is permanently stored in, active memory along with the appropriate drivers for communication with the various interfaces. In other embodiments, other operating systems such as Microsoft Corporation's Windows CE™ could be used without departing from the present invention. Along with the operating system and associated drivers, the STB 22 usually operates using browser software 182 in active memory or may permanently reside in ROM, EEPROM or Flash memory, for example. The browser software 182 typically operates as the mechanism for viewing not only web pages on the Internet, but also serves as the mechanism for viewing an Electronic Program Guide (EPG) formatted as an HTML document. The browser 182 can also provide the mechanism for viewing normal programming (wherein normal programming is viewed as an HTML video window—often occupying the entire area of screen 26).

STB software architectures vary depending upon the operating system. However, in general, all such architectures generally include, at the lowest layer, various hardware interface layers. Next is an operating system layer as previously described. The software architectures of modern STB have generally evolved to include a next layer referred to as “middleware.” Such middleware permits applications to run on multiple platforms with little regard for the actual operating system in place. Middleware standards are still evolving at this writing, but are commonly based upon Javascript and HTML (hypertext Markup Language) virtual machines. At the top layer is the application layer where user applications and the like reside (e.g., browsing, email, EPG, Video On Demand (VOD), rich multimedia applications, pay per view, etc.). The current invention can be utilized with any suitable set-top box software and hardware architecture.

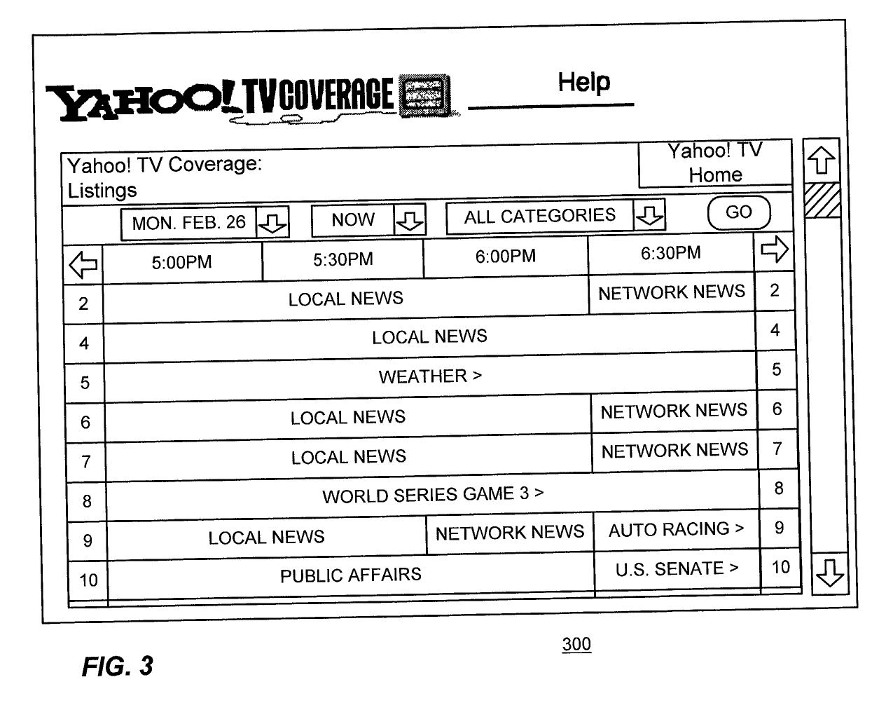

Referring back to FIG. 1, if a user of set-top box 22 desires to utilize a program guide other than a program guide provided by the service provider 10 by tuning to a specified channel, the present invention facilitates access to web based programming guides such as that illustrated in FIG. 3. FIG. 3 shows an exemplary program guide similar to that provided by YAHOO!™ and illustrated as 300. A program guide such as guide 300 or others which are based on the Internet 44 can be accessed by addressing the URL for the program guide using a browser. Such a program guide may reside, for example, at a remote server 48 as illustrated in FIG. 1. Since set-top box 22 includes a browser 182, it can be utilized to access the Internet 44 through either a cable modem or an out-of-band modem forming part of the set-top box 22 to display a web-based EPG on the television display 26 without resort to a separate computer.

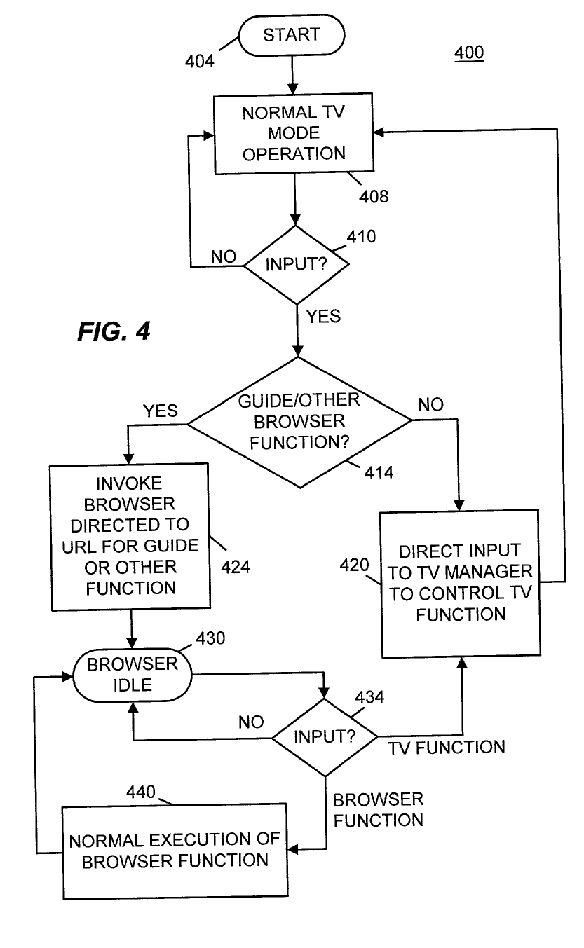

In order for the user to enjoy a comfortable and familiar electronic program guide experience, the present invention, in certain embodiments, utilizes a process illustrated as process 400 of FIG. 4. This process starts at 404 with turning on the television set or set-top box incorporating the invention. After the device is powered up and initialized, the set-top box 22 (in the preferred embodiment) enters a mode of operation at 408 that provides normal television functions. That is, the television displays the programming of the currently tuned (or most recently selected) television channel. The television remains in this mode of operation at 408 until an appropriate input is received at 410. Such an input at 410 might include; for example, a command executed from a remote control 36 or from a front panel control of the set-top box or other connected device. In order to make the transition to a web based EPG smooth and seamless, the set-top box determines at 414 that the input command received at 410 is directed toward a browser function such as display of the electronic program guide. If not, control passes to 420 where the input is directed to the TV manager software module to implement control of the TV function in a conventional manner. Control then passes back to 408. The television manager utilized in the preferred embodiment of the present invention is described in greater detail in U.S. patent application Ser. No. ______ filed Feb. 3, 2001 entitled Web Browser Plug in for TV to Kimble et al. Docket No. 50N3463, which is hereby incorporated by reference. The TV manager module, however, for purposes of this invention, is simply a software module or modules that interfaces directly or indirectly with a television tuner and other television components to implement television functions such as changing of channels, adjusting of volume and other television functions as distinguished from conventionally browser related functions.

In the event a program guide or other browser related function is being invoked by the input at 410 at 414, browser 182 is invoked at 424 and immediately directed to the URL associated with the users default program guide (or other function associated with the browser.) Thus, the browser is invoked and immediately directed to the electronic program guide for display on the television display 26 after which point the browser goes either at 430 awaiting the next input. The URL's associated web page is accessed either through a cable modem or out-of-band modem to the preferred cable embodiment in order to take advantage of the high speed of their relatively high speed, to thus enhance the responsiveness of the system. When an input is received at 434, a determination is made as to whether or not the input relates to a browser function or to a television function. If the input relates to a television function, the input is diverted at 434 to 420 where the television manager module implements the control function and passes control back to 408. However, if the input relates to a browser function (for example, directing the browser to a new web site or filing in text boxes at browser's currently opened page) and focus point (the location of the cursor or pointer), control passes to 440. At 440, the browser executes normal functions in a conventional manner and then returns to the browser idle state at 430. In this manner, the user's desire to invoke a web based electronic program guide occurs seamlessly upon execution of appropriate command to retrieve the EPG. Thus, the user's experience is similar to that provided by use of a service provider's electronic program guide in that the user simply invokes the guide by sending a simple command from a remote control, etc.

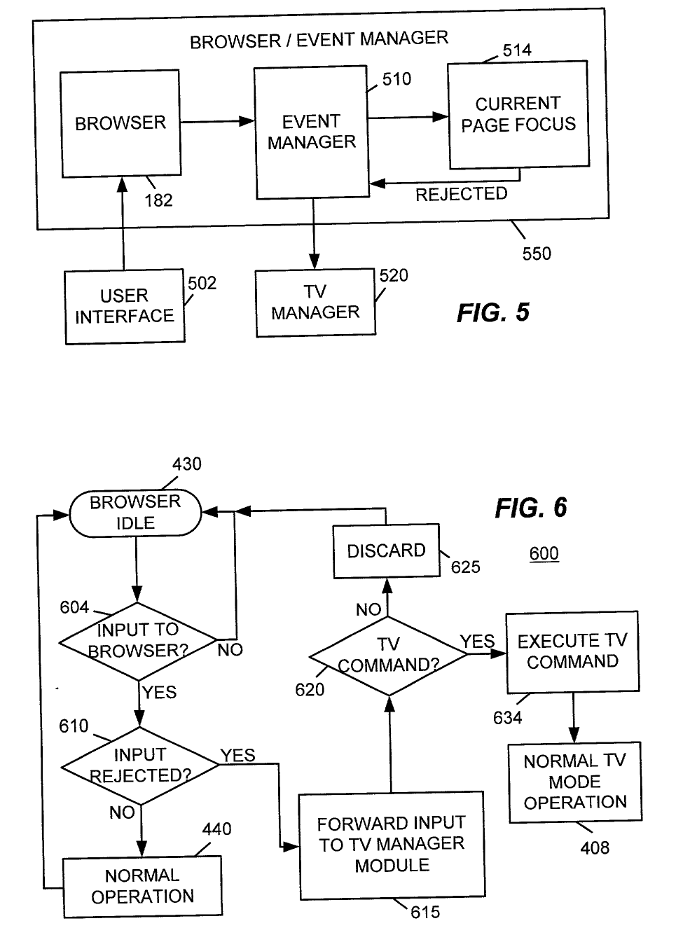

With reference to FIG. 5, the interaction of the various software modules is illustrated in greater detail. Input from a user interface 502 is directed to browser 182 whenever the browser is invoked. This input is interpreted and passed through an event manager module 510 to direct the input to the current focus of the displayed web page illustrated as 514. In the event the input from user interface 502 is appropriate to the current web page focus at 514, the browser carries out normal execution of the function associated with the input. For example, if the input corresponds correctly to clicking an icon on the current page, the browser implements that function. Similarly, if the user input appropriately enters text data into a text box having the current focus on the current web page, the browser enters the text accordingly. However, consider the situation where numerical data is entered from a keyboard or remote control 36 but the current cursor location (focus) on the current web page is not at a location that permits text entry. In this event, the input is rejected and the event manager 510, alerted to such rejection, determines that the command should properly be directed to the TV manager 520. The event manager 510 thus forwards the input to the TV manager 520 for action. In this manner, TV control inputs can be differentiated from normal interaction with browser 182. In the preferred embodiment, an event manager 510 is integrated within browser 182 to produce browser/event manager 550. Those skilled in the art will recognize that other implementations are possible.

Referring now to FIG. 6, process 600 is illustrated which defines the actions associated with browser/event manager 550. In particular, process 600 describes how input is handled when the browser is in the idle state 430. The browser rests in the idle state until an input is received at 604. When the input is received it is passed to the event manager 510 destined for the current web page focus 514. If that input is not rejected at 610, normal browser operation is carried out at 440 to execute the browser function. Control then returns to the browser idle state at 430. If the input is rejected at 610, the input is forwarded to the TV manager module 520 at 615. The TV manager 520 determines at 620 if the input being received is a television command input. If not, some type of error has likely occurred and the input is discarded at 625. Control then returns from 625 to the browser idle state at 430. However, if the input corresponds to a TV command at 620, the TV command is executed at 634 before returning the television to normal operational mode at 408. Thus, if, for example, the current web page focus at 514 is not at a text entry location and the user input is a number from the number key pad of remote control 36, the event manager 510 forwards the command to the TV manager module at 615 and at 634 the TV manager determines that the user wishes to change channels and executes the command. Control then reverts to the normal TV mode of operation at 408.

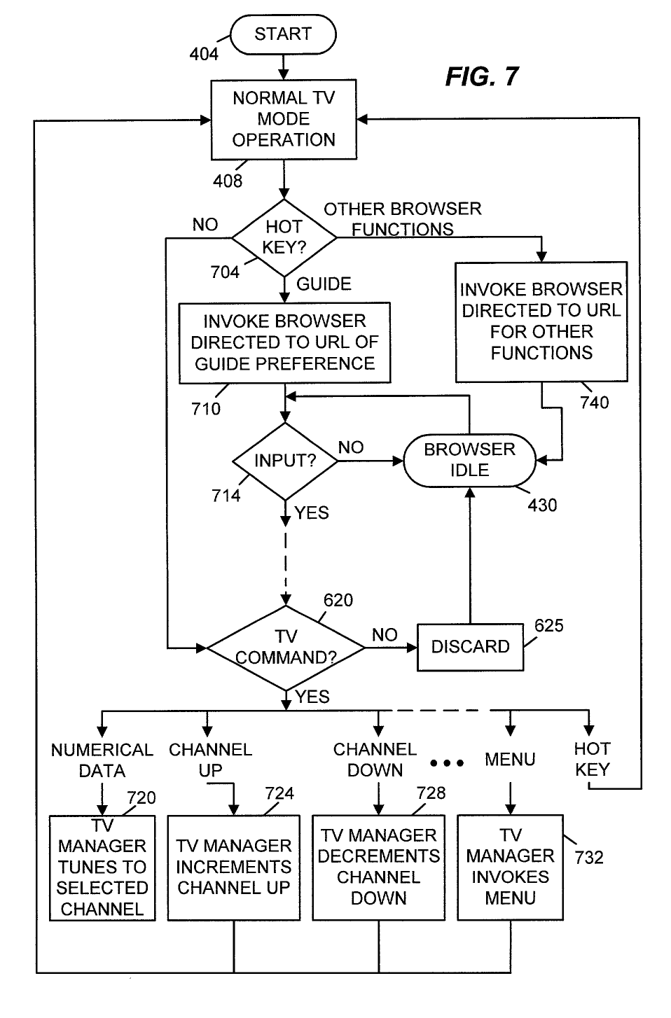

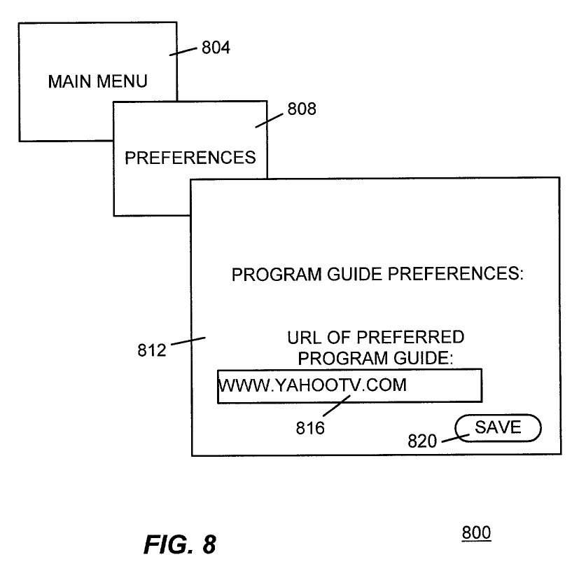

Referring now to FIG. 7, a more detailed process 700 of the transition between TV mode and browser idle mode 430 is illustrated with exemplary TV commands. This process again starts at 404 after which the set-top box 22 or television is placed in the normal TV mode of operation at 408. In accordance with certain preferred embodiments, a “hot key” can be utilized to enter the browser mode. For example, remote control 36 may be provided with a key which invokes the electronic programming guide which may be considered a hot key. Other browser functions may also, in certain embodiments, be invoked using a hot key to access those functions (for example, electronic mail and web surfing.) If a hot key is executed by the user at 704, and the hot key directs the system to implement an electronic program guide, the browser is invoked at 710 and directed to a URL set by the user or manufacturer to provide the default or preferred electronic program guide. If there is no further input, the browser then enters the browser idle state at 430. If an input is received at 714 and the input relates to a TV command at 620, or if a hot key executed at 704 corresponds to a TV command (such as a command to jump to the last channel viewed) then the command is interpreted at 620 by the TV manager 520. By way of example, and not limitation, if the TV command is numerical data, control passes to 720 where the TV manager tunes to selected channel. Control then passes back to 408 for normal TV mode operation. Similarly, if the TV command is a channel up command, control passes to 724 where the TV manager increments the channel before returning control to 408. Similarly, if the TV command at 620 is a channel down command, control passes to 728 where the TV manager decrements the channel. If the TV command at 620 is a menu command, the TV manager invokes a menu for set-top box functions at 732 before returning control to 700 for normal TV mode operation. In a similar manner, if a hot key is again executed, control returns from the browser back to normal TV mode operation at 408. Those skilled in the art will recognize that any other television command can similarly be implemented (e.g., volume controls, special functions such as picture-in-picture, etc.)

If at 620 the command implemented is not a TV command, an error is assumed to have occurred and the command is discarded at 625 before returning back to the browser idle state at 430. In certain embodiments, other hot key functions such as access to e-mail or other special web sites can be similarly implemented, in which case control passes from 704 upon receipt of such a hot key command to 740 where the browser is invoked and directed to the appropriate URL for the desired function before returning to the browser idle state at 440.

In accordance with certain embodiments of the present invention, the user can determine which browser is to be used upon execution of the hot key. In one embodiment, a system of menus is provided through a TV command to a main menu 884. The main menu can then be negotiated to reach a preferences menu 808 where program guide preferences can be selected at 812. In the program guide preferences menu, a preferred electronic program guide URL can be entered into a text box 816 after which a “save” icon 820 is executed. In this manner, the preferred program guide can be any suitable web page providing such services and transition to that electronic program guide is seamless and nearly as transparent to the user as if the service provider were providing the guide as a television channel. Moreover, such program guides can be cached at the service provider head end to assure rapid access to the program guide whenever an appropriate hot key is executed by the user.

Those skilled in the art will recognize that the present invention has been described in terms of exemplary embodiments based upon use of a programmed processor. However, the invention should not be so limited, since the present invention could be implemented using hardware component equivalents such as special purpose hardware and/or dedicated processors which are equivalents to the invention as described and claimed. Similarly, general purpose computers, microprocessor based computers, micro-controllers, optical computers, analog computers, dedicated processors and/or dedicated hard wired logic may be used to construct alternative equivalent embodiments of the present invention.

Those skilled in the art will appreciate that the program steps used to implement the embodiments described above can be implemented using disc storage as well as other forms of storage including Read Only Memory (ROM) devices, Random Access Memory (RAM) devices; optical storage elements, magnetic storage elements, magneto-optical storage elements, flash memory, core memory and/or other equivalent storage technologies without departing from the present invention. Such alternative storage devices should be considered equivalents.

The present invention is preferably implemented using a programmed processor executing programming instructions that are broadly described above in flow chart form and can be stored on any suitable electronic storage medium. However, those skilled in the art will appreciate that the processes described above can be implemented in any number of variations and in many suitable programming languages without departing from the present invention. For example, the order of certain operations carried out can often be varied, and additional operations can be added without departing from the invention. Error trapping can be added and/or enhanced and variations can be made in user interface and information presentation without departing from the present invention. Such variations are contemplated and considered equivalent.

While the invention has been described in conjunction with specific embodiments, it is evident that many alternatives, modifications, permutations and variations will become apparent to those skilled in the art in light of the foregoing description. Accordingly, it is intended that the present invention embrace all such alternatives modifications and variations as fall within the scope of the appended claims.

What is claimed is:

1. A method of tuning a television channel while displaying a web-based program guide, comprising:
generating a video signal to display the web-based program guide using a web browser application, the display indicating a cursor location;
receiving an input signal;
determining that the input signal is unmatched to the current cursor location; and
redirecting the input signal to a television manager.

2. The method according to claim 1, further comprising:
at the television manager, determining that the input signal corresponds to a television command; and
implementing the television command.

3. The method according to claim 1, carried out in a Television Set-Top Box.

4. The method according to claim 1, wherein the determining and redirecting are carried out in an event manager.

5. The method according to claim 1, wherein an input signal corresponding to a user actuation of a numerical character 0-9 is considered to be unmatched if the cursor is not situated at a text entry field of the web-based program guide.

6. The method according to claim 5, wherein the actuation of a numerical character 0-9 is considered to be a channel selection command if the cursor is not situated at a text entry field of the web-based program guide; and wherein the television manager implements a channel selection function in response thereto.

7. The method according to claim 1, wherein the receiving comprises receiving the input signal from a television remote control.

8. A television Set-Top Box, comprising:
a programmed processor;
a web browser running on the programmed processor, the web browser accessing a web page as a current web page;
an input receiving a user input signal, wherein the user input signal may be directed either to a television control action or to the current web page;
a television manager that receives user input signals and implements television control actions in response thereto; and
an event manager that directs the input signal to the television manager in the event the input signal is not directed to the current web page.

9. The apparatus according to claim 8, wherein the current web page comprises a web-based program guide page.

10. The apparatus according to claim 9, wherein the current web page has a cursor location, and wherein the event manager determines that the input signal is not directed to the current web page if the input signal is not matched to the current cursor location.

11. The apparatus according to claim 10, wherein an input signal corresponding to a user actuation of a numerical character 0-9 is considered to be a channel selection command if the cursor is not situated at a text entry field of the current web page.

12. The apparatus according to claim 11, wherein the television manager implements a channel selection function in response to the channel selection command.

13. The apparatus according to claim 8, wherein the input receives the user input signal from a television remote control.

14. An electronic storage medium storing instructions which, when executed on a programmed processor, carry out a process of tuning a television channel, comprising:
generating a video signal to display a web-based program guide using a web browser application, the display indicating a cursor location;
receiving an input signal;
determining that the input signal is unmatched to the current cursor location; and
redirecting the input signal to a television manager.

15. The electronic storage medium according to claim 14, further comprising:
at the television manager, determining that the input signal corresponds to a television command; and
implementing the television command.

16. The electronic storage medium according to claim 14, wherein an input signal corresponding to a user actuation of a numerical character 0-9 is considered to be unmatched if the cursor is not situated at a text entry field of the web-based program guide.

17. The electronic storage medium according to claim 16, wherein the actuation of a numerical character 0-9 is considered to be a channel selection command if the cursor is not situated at a text entry field of the web-based program guide; and wherein the television manager implements a channel selection function in response thereto.

18. The electronic storage medium according to claim 14, wherein the receiving comprises receiving the input signal from a television remote control.

19. A method of invoking an electronic program guide, comprising:
producing a video signal corresponding to a television program;
receiving an input command to display a program guide;
invoking a web browser application directed to a Universal Resource Locator (URL) calling a web-based program guide; and
producing a video signal to display the web-based program guide.

20. The method according to claim 19, further comprising again receiving the input command to display the program guide; and
resuming producing the video signal corresponding to the television program.

21. The method according to claim 19, further comprising establishing a default URL for a the web-based program guide and storing the default URL in a memory.

22. A method of changing from a television mode to a browser mode, comprising:
producing a video signal corresponding to a television program;
receiving an input command;
invoking a web browser application directed to a default Universal Resource Locator (URL) in response to the input command; and
producing a video signal to display a web page corresponding to the URL.

23. The method according to claim 22, further comprising again receiving the input command; and
resuming producing the video signal corresponding to the television program.

24. The method according to claim 22, further comprising establishing a default URL for a the web-based program guide and storing the default URL in a memory, and wherein the input command comprises a command to retrieve a program guide.

25. A television Set-Top Box, comprising:
a programmed processor;
a web browser application that runs on the programmed processor;
an input receiving a user input signal, wherein the user input signal comprises a command to display a program guide, the command being passed from the input to the programmed processor; and
wherein, the programmed processor invokes the web browser application directed to a Universal Resource Locator (URL) calling a web-based program guide page as a result of the input receiving the command to display a program guide.

26. The apparatus according to claim 25, further comprising:
a television manager that controls television functions; and
an event manager that directs the input signal to the television manager in the event the input signal is not directed to the web-based program guide page.

27. The apparatus according to claim 26, wherein the program guide has a cursor location, and wherein the event manager determines that the input signal is not directed to the web-based program guide page if the input signal is not matched to the current cursor location.

28. The apparatus according to claim 27, wherein an input signal corresponding to a user actuation of a numerical character 0-9 is considered to be a channel selection command if the cursor is not situated at a text entry field of the web-based program guide page.

29. The apparatus according to claim 28, wherein the television manager implements a channel selection function in response to the channel selection command.

30. The apparatus according to claim 25, wherein the input receives the user input signal from a television remote control.
